(19) United States
(12) Patent Application Publication
(10) Pub. No.: US 2005/0110871 A1
(43) Pub. Date: May 26, 2005

(54) Video display apparatus, video signal output apparatus, and pictorial pattern displaying method

(75) Inventor: Tomotaka Ida, Tano-gun (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/943,235

(22) Filed: Sep. 17, 2004

(30) Foreign Application Priority Data
Nov. 21, 2003 (JP) 2003-392611

(51) Int. Cl. H04N 5/445

(52) U.S. Cl. 348/173; 348/564; 348/553

(57) ABSTRACT

A video display apparatus which causes phosphors coated on a screen to emit light, thereby displaying images on the screen, the video display apparatus comprises a storage section which stores a plurality of pictorial patterns, a pattern displaying function which displays the pictorial patterns stored in the storage section on the screen sequentially, and a start-up section which causes the pattern displaying function to start automatically when a preset start condition is satisfied and carry out a pictorial pattern displaying process.

### CROSS-REFERENCE TO RELATED APPLICATIONS

This application is based upon and claims the benefit of priority from prior Japanese Patent Application No. 2003-392611, filed Nov. 21, 2003, the entire contents of which are incorporated herein by reference.

### BACKGROUND OF THE INVENTION

1. Field of the Invention

This invention relates to a video display apparatus which displays images using phosphors. Video display apparatuses of this type include a plasma display apparatus and a CRT display. This invention further relates to a video signal output apparatus which outputs a video signal to display images on this type of video display apparatus. This type of display apparatus is called a set top-box (STB). This invention further relates to a method of displaying a pictorial pattern on the video display apparatus. More particularly, this invention relates to an improvement in the function of averaging a burn-in phenomenon liable to occur in this type of video display apparatus in order to make the phenomenon inconspicuous.

2. Description of the Related Art

A panel display apparatus (hereinafter referred to as PDP), such as a plasma display apparatus, displays an image by causing pixels to discharge at a high voltage and allowing ultraviolet rays generated by the discharge to cause the phosphors to emit light. The phosphors deteriorate in proportion to the operating time and the amount of emitted light to the amount of ultraviolet rays decreases. For example, when part of the phosphors have displayed a white image for many hours, only the white part of the phosphors are used and deteriorated. In this state, if white is all over the screen, the luminance of the deteriorated part becomes lower than that of the remaining part, which permits the part to be recognized easily. The phenomenon that the luminance decreases as a result of the deterioration of the phosphors is known as a burn-in phenomenon.

Burn-in also occurs on CRT displays. In the PDP, since intense discharging is done in very small pixels, degradation of the phosphors is serious and the phosphor deteriorates in a shorter time than the CRT display. Basic measures against burn-in in the PDP include increasing light emission efficiency by improving the phosphor material or reexamining the pixel structure. However, since these approaches require a drastic improvement in the panel itself, it is difficult to realize higher light emission efficiency soon.

With this backdrop, a video display apparatus having the function of making burn-in inconspicuous has been provided. The screen protecting function included in this type of video display apparatus includes, for example, the function of burning the display uniformly by displaying white all over the screen. In addition to this, the screen protecting function includes the function of burning parts of the screen less liable to be burned in a normal operation, by reversing the luminance of the whole screen.

In the existing video display apparatus, since the screen protecting function is designed to be started by the user's operation on the menu screen, this increases the user's load. In addition, it is difficult for the user to determine whether to start the screen protecting function according to the degree of burn-in, the operating time of the display, and a suitable pictorial pattern. If the setting were inadequate, that might be counterproductive. Thus, it is desirable that the user shouldn't be allowed to set screen protecting function, if possible.

Naturally, a program cannot be watched while the screen protecting function is in operation. Moreover, the user may have to observe the screen in that state until the screen protecting function has been canceled, which increases the user's load further.

Related techniques have been disclosed in Jpn. Pat. Appln. KOKAI Publication No. 2001-228846 (reference 1). This reference has disclosed a display burn-in prevention apparatus which stores still images having a great effect on burn-in and reverses the stored still images, thereby alleviating burn-in. The apparatus disclosed in the reference requires the maintenance mode to be started manually to provide a reverse display of images, which needs the user (including a serviceman) to take trouble to start the mode.

Another known video display apparatus alleviates burn-in by performing only picture inversion automatically at intervals of a set time. Since a suitable pictorial pattern according the state of the display cannot be determined in an intelligent manner, it is difficult to say that burn-in can be prevented effectively.

As described above, the screen protecting function of the existing video display apparatus has disadvantages in that it requires manual operations, thus increasing the user's load and that it is difficult to alleviate burn-in effectively.

### BRIEF SUMMARY OF THE INVENTION

According to an aspect of the present invention, there is provided a video display apparatus which causes phosphors coated on a screen to emit light, thereby displaying images on the screen, the video display apparatus comprises a storage section which stores a plurality of pictorial patterns, a pattern displaying function which displays the pictorial patterns stored in the storage section on the screen sequentially, and a start-up section which causes the pattern displaying function to start automatically when a preset start condition is satisfied and carry out a pictorial pattern displaying process.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a functional block showing an embodiment of a video display apparatus according to the present invention;

FIG. 2 is a functional block diagram schematically showing the control function of the control section 108 in FIG. 1;

FIG. 3 is a flowchart showing the processing procedure in a first embodiment of the video display apparatus in FIGS. 1 and 2;

FIG. 4 is a flowchart for a more detailed procedure in the flowchart of FIG. 3;

FIG. 5 shows an example of the menu screen for setting the long-life function;

FIG. 6 shows an example of the time setting screen for setting the start time of the long-life function;

FIG. 7 is a second flowchart showing a more detailed procedure in the flowchart of FIG. 3;

FIG. 8 is a third flowchart showing a more detailed procedure in the flowchart of FIG. 3;

FIG. 9 shows a message screen to inform the user of the start of the long-life function;

FIG. 10 shows a message screen to inform the user of the interruption of the long-life function;

FIGS. 11A to 11D show a plurality of pictorial patterns and an example (pattern A) of their display sequence;

FIG. 12 shows a message screen to inform the user of the end of the long-life function;

FIG. 13 is a flowchart to help explain the processing procedure in a second embodiment of the video display apparatus in FIGS. 1 and 2;

FIG. 14 shows a message screen to inform the user of the start of the long-life function (before power-off);

FIG. 15 shows a message screen to recommend starting the long-life function;

FIGS. 16A to 16F show a plurality of pictorial patterns and another example (pattern B) of their display sequence; and

FIGS. 17A to 17F show a plurality of pictorial patterns and still another example (pattern C) of their display sequence.

### DETAILED DESCRIPTION OF THE INVENTION

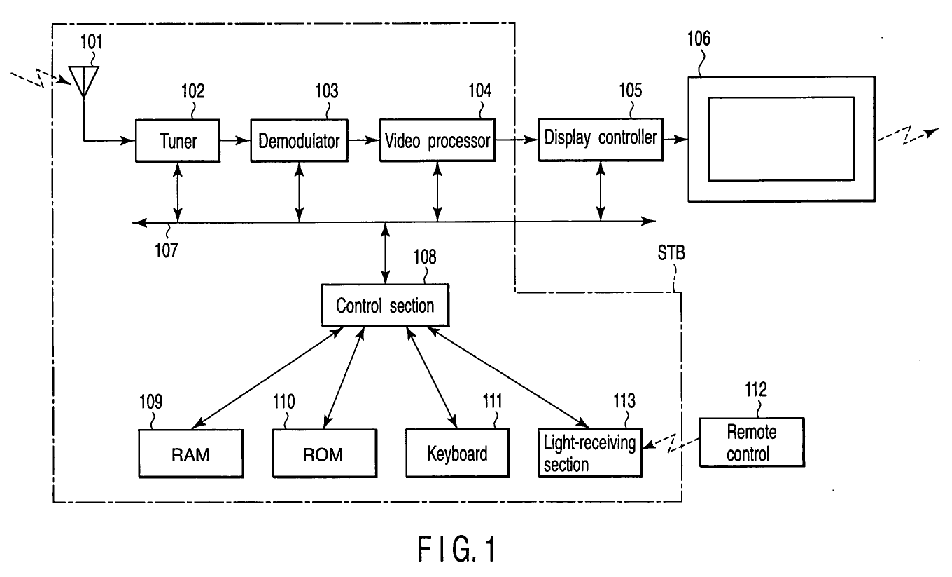

FIG. 1 is a functional block diagram showing an embodiment of a video display apparatus according to the present invention. The video display apparatus (hereinafter, also referred to as the TV set) of FIG. 1 includes a display (indicated by reference numeral 106) liable to burn-in, such as a plasma display. The display 106, which has a screen coated with phosphors, causes the phosphors to emit ultraviolet rays, thereby displaying images on the screen.

In FIG. 1, broadcast waves radiated from broadcasting stations (not shown) are received by an antennal 101. A tuner 102 selects a channel signal from the broadcast waves. The channel signal is inputted to a demodulator 103, which demodulates a video signal. The video signal is adjusted by a video processor 104 so as to have a suitable image size and colors. The video signal is further converted by a display controller 105 into a signal unique to a display 106 and then supplied to the display 106. As a result, an image appears on the display 106. The tuner 102, demodulator 103, video processor 104, and display controller 105 are connected to a control section 108 via a bus 107.

The control section 108 supervises the signal processing in the tuner 102, demodulator 103, video processor 104, and display controller 105. In addition, the control section 108 is connected to a RAM (Random Access Memory) 109, a ROM (Read Only Memory) 110, a keyboard 111, and a light-receiving section 113. The RAM 109 stores temporary data produced in a calculation process or the like.

The ROM 110 is a nonvolatile memory for storing data, such as setting parameters. This type of memory includes EEPROM (Electrically Erasable Programmable Read-Only Memory). The ROM 110 stores a plurality of pictorial patterns and the contents of the display on the message screen appearing on the display 106. The pictorial patterns should be best suited to reduce burn-in according to the characteristics of the display 106. The keyboard 111 is a user interface for receiving various operations from the user. The light-receiving section 113 receives an infrared ray signal from a remote control 112 and informs the control section 108 of the user's operations in the form of events.

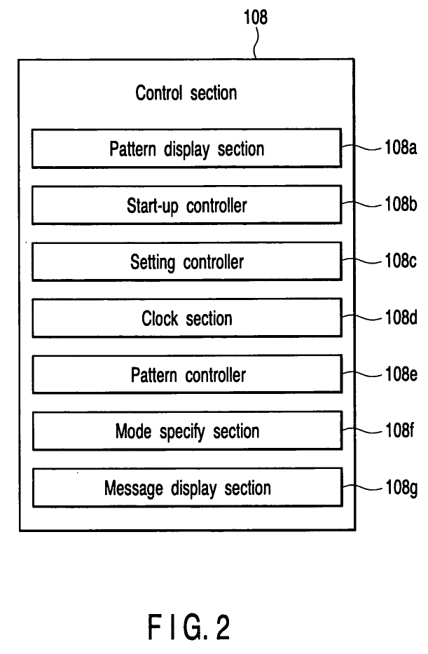

FIG. 2 is a functional block diagram schematically showing the control function included in the control section 108 of FIG. 1. As shown in FIG. 2, the control section 108 includes a pattern display section 108a, a start-up controller 108b, a setting controller 108c, a clock section 108d, a pattern controller 108e, a mode specify section 108f, and a message display section 108g.

The pattern display section 108a reads pictorial patterns stored in the ROM 110 sequentially and displays them on the display 106. As a result, a plurality of pictorial patters are displayed sequentially, which enables the display 106 to be protected from burn-in. Hereinafter, a burn-in alleviating function activated when the pattern display section 108a is started is referred to as a long-life function.

The start-up controller 108b starts the long-life function, when a start condition preset by the user's initial setting operation is fulfilled. Specifically, when the start condition is met, the start-up controller 108b loads a program routine for the pattern display section 108a from the ROM 110 into the control section 108 and causes the control section 108 to start processing. The start condition includes the arrival of a predetermined start time and the turning off of the power supply of the TV set.

When the start condition has been met with the power supply of the TV set being off, the start-up controller 108b turns on the power supply of the TV set, thereby starting the long-life function. In addition, when the start condition has been met with the power supply of the TV set being on (that is, while the user is watching television), the start-up controller 108b displays, on the display 106, a message to ask the user whether to start the long-life function. If the user's permission is given, the start-up controller 108b starts the long-life function.

The setting controller 108c displays, on the display 106, a setting screen to prompt the user to set a start time to start the long-life function. When the start time has been set via the setting screen, the setting controller 108c stores the start time in the ROM 110. The clock section 108d measures the accumulated time during which the power supply of the TV set is on. In addition, the clock section 108d measures the elapsed time since the power supply of the TV set was turned on last.

The pattern controller 108e varies at least one of the order in which a plurality of pictorial patterns are displayed on the display 106 and the display time of each of the pictorial patterns, according to the accumulated time measured at the clock section 108d or to the elapsed time. Specifically, the pattern controller 108e controls the order in which the pictorial patterns are read by the pattern display section 108a from the ROM 110 and the presence or absence of reading. When a certain pictorial pattern is not displayed, the display time of the pictorial pattern is set to zero.

The mode specify section 108f enables the user to select and specify an enable mode/disable mode related to the activation/deactivation of the long-life function. In the enable mode, when the start condition has been met, the long-life function is started automatically. In the disable mode, the long-life function is not started, regardless of whether the start condition has been met. When the accumulated time measured at the clock section 108d or the elapsed time has exceeded a specified value, with the disable mode being selected at the mode specify section 108f, the massage display section 108g displays a message screen to prompt the user to start the long-life function.

The functions realized by the pattern display section 108a, start-up controller 108b, setting controller 108c, clock section 108d, pattern controller 108e, mode specify section 108f, and message display section 108a are carried out by the control section 108 in software under the control of the control program stored in, for example, the ROM 110.

Next, the operation of the above configuration will be explained using three embodiments.

[First Embodiment]

In a first embodiment of the present invention, a time to start the long-life function is set and the long-life is started when the set time has been reached. The first embodiment will be explained below.

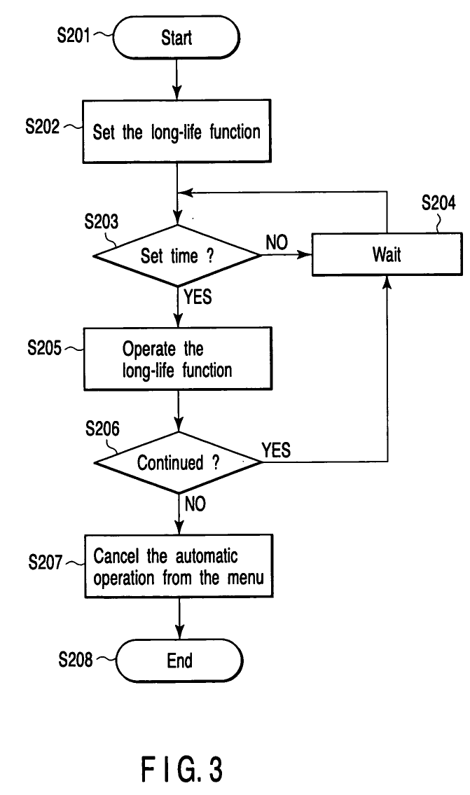

FIG. 3 is a flowchart to help explain the processing procedure in the first embodiment of the image display apparatus in FIGS. 1 and 2. In FIG. 3, a setting process related to the long-life function is started (step S201). Then, a menu screen for setting a start time of the long-life function appears on the display 106. The user sets, via the menu, a desired time at which the long-life function is started (step S202). The time band during which television is less liable to be watched, such as the bedtime band, should be set as the start time according to the user's life style.

After the start time is set, the TV set starts to monitor the present time and waits for the set time to be reached (step S203). Until the set time has been reached, the TV set is in the standby state (step S204). In this state, the user can carry out a normal TV operation, such as watching a program.

When the present time has reached the set time, the long-life function is started. Then, the screen protecting operation is started (step S205) and a plurality of pictorial patterns appear on the display 106 sequentially. After the last pattern is displayed, the user is asked whether the long-life function should be cancelled, to determine whether to continue waiting for the start time to be reached (step S206).

In this step, when the user has operated to cancel the long-life function (No), a menu screen appears. Using the menu, the user cancels the automatic operation of the long-life function, which completes the process (step S208). On the other hand, if the long-life function is kept operating in step S206 (Yes), the processing procedure returns to step S204, where the standby state is continued.

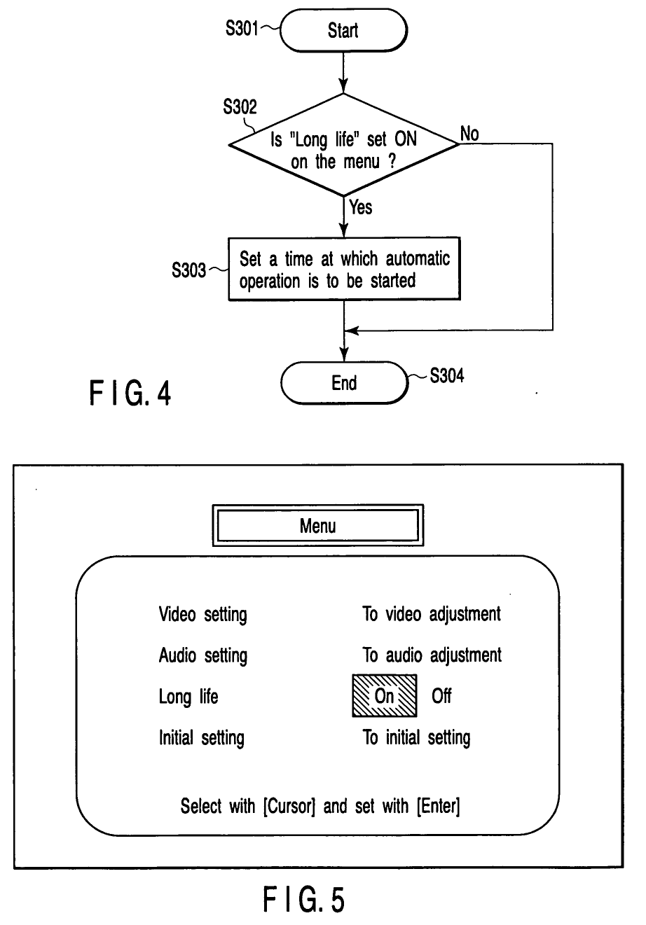

FIG. 4 is a flowchart for a more detailed procedure in the flowchart of FIG. 3. In FIG. 4, step 202 and step S207 in FIG. 3 are shown in detail. Step S301 in FIG. 4 is the starting point for the process of setting the long-life function from a menu. For example, as a result of operating the remote control 112, a menu screen as shown in FIG. 5 is called up. In the menu screen, a plurality of setting fields are provided. An on/off setting item is displayed so as to correspond to “Long life.” In step S302 of FIG. 4, the item On or Off is selected.

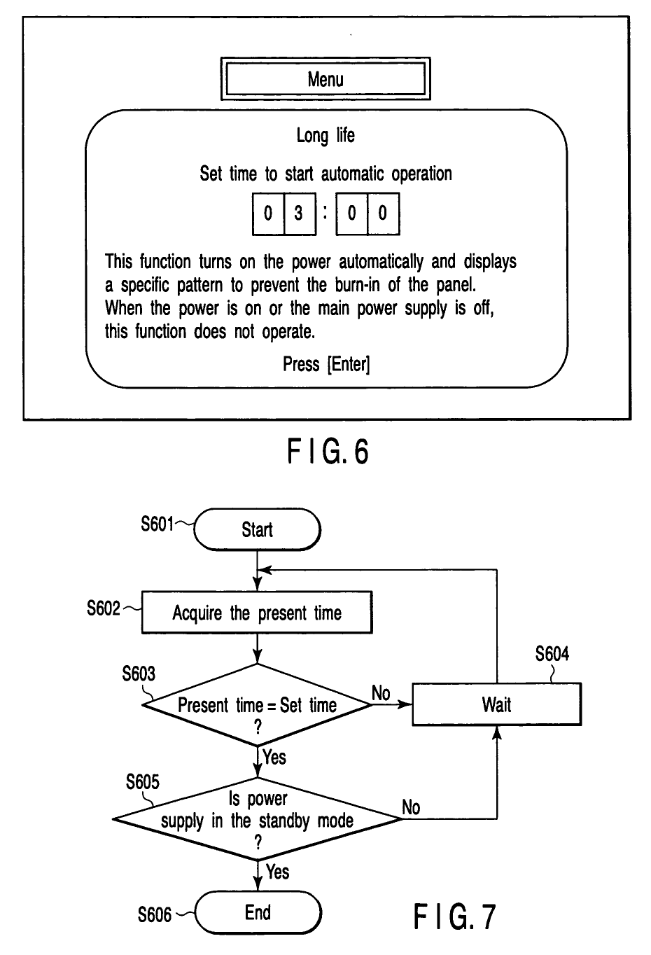

If On is selected in step S302 (Yes), a time setting screen in FIG. 6 appears. In the screen, a field for specifying a time from a scroll or pull-down menu is provided. The user sets a desired start time using the screen (step S303 in FIG. 4). FIG. 6 shows “03:00” as the start time, meaning that the user has specified that the long-life function is to be started up at 3:00 a.m. The set start time is stored in the ROM 110.

After the time setting is completed in FIG. 4, the setting procedure is ended (step S304). To cancel the long-life function, the item Off is selected in the long-life function setting field from the menu of FIG. 4 (No in step S302 of FIG. 4). In this case, the processing procedure goes directly from step S302 to step S304, where the long-life function is canceled. The state where the long-life function is cancelled corresponds to the disable mode. The state where the long-life function is not cancelled corresponds to the enable mode. Information indicating which mode the TV set is in is stored in the ROM 110.

FIG. 7 is a second flowchart showing a more detailed procedure in the flowchart of FIG. 3. In FIG. 7, the detail of step S203 in FIG. 3 is shown. The start step S601 in FIG. 7 corresponds to the state immediately after the long-life function is set. Next, the control section 108 acquires the present time and stores the acquired time in the RAM 109 (step S602). Next, the control section 108 reads the start setting time of the long-life function from the ROM 110 and compares it with the present time (step S603). If the present time is not equal to the set time, the processing procedure goes through the standby state (step S604) and returns to step S602, where the present time is acquired again.

While step S602 to step S604 are being repeated, the set time has been reached (Yes in step S603). Then, the start-up state of the power supply of the TV set and the mode are checked (step S605). If the AC power supply of the TV set is disconnected, the long-life function does not start from the very beginning. On the other hand, if the AC power supply of the TV set is connected, there are two modes: one is a program viewing mode in which TV images appear on the display 106 and the other is a power off mode with AC connected, that is, the standby mode (as a result of, for example, the power supply being turned off by the remote control).

If the TV set is in the program viewing mode at the time when the set time has been reached (No in step S605), priority is given to the user's viewing and the long-life function is not started in the first embodiment. Then, the processing procedure returns to step S604. In contrast, if the TV set is in the standby mode at the time when the set time has been reached (No in step 605), the processing procedure goes to step 606. As a result, the standby state ends and the long-life function is started.

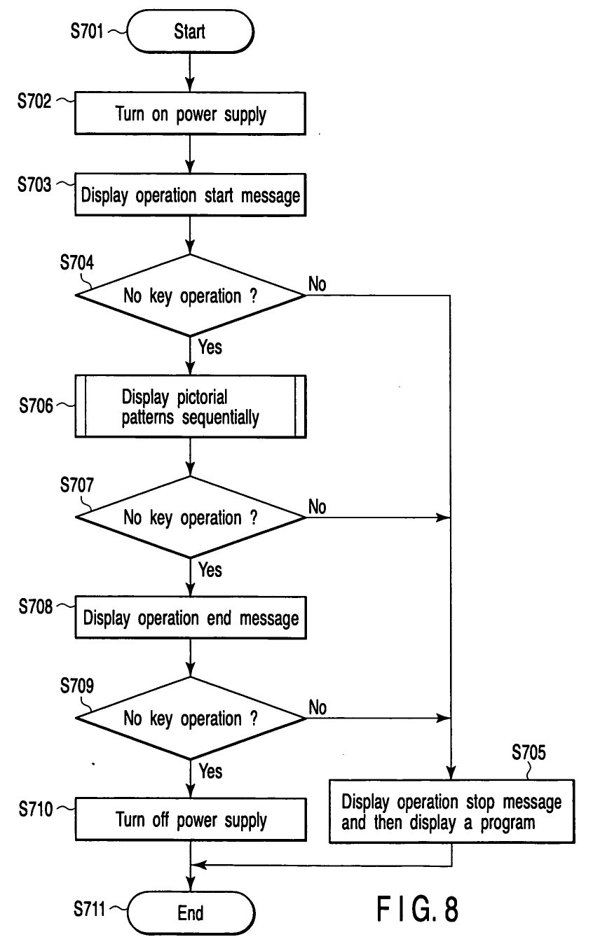

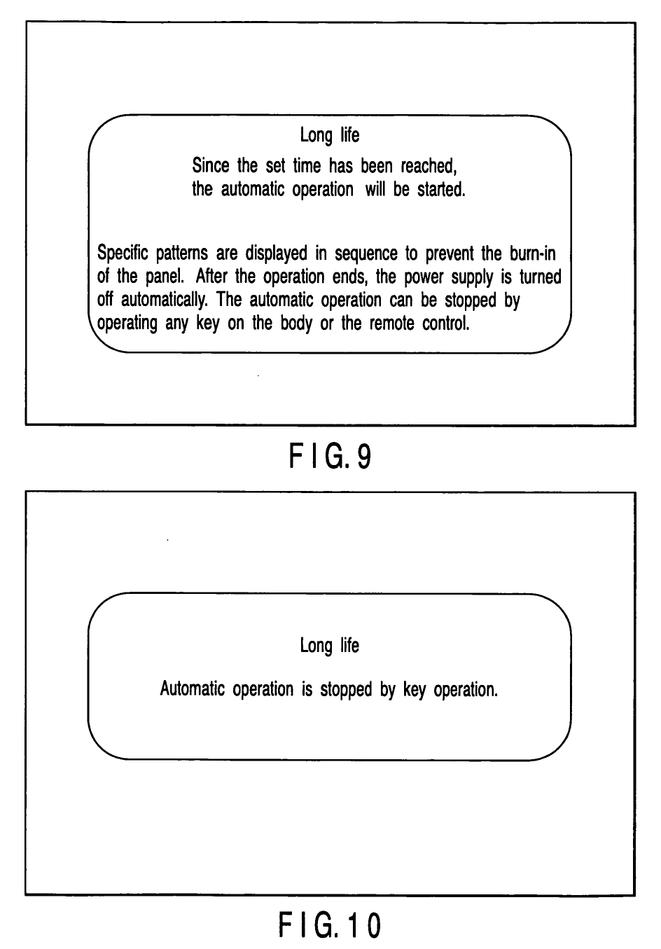

FIG. 8 is a third flowchart showing a more detailed procedure in the flowchart of FIG. 3. In FIG. 8, a detailed procedure of step S205 in FIG. 3, that is, of the long-life function is shown. The start step S701 in FIG. 8 corresponds to the stating point for the process of staring the long-life function when the set time has been reached. When the set time has been reached, the power supply of the TV set is turned on automatically (step S702). Then, as shown in FIG. 9, a message screen to indicate that the operation of the long-life function is going to be started appears on the display (step S703).

On the screen in FIG. 9, not only the message about the start of the long-life function but also a method of stopping the function is shown. Specifically, if any interrupt event occurs as a result of the operation of the remote control 112 or the keys on the body, while the long-life function is in operation, the long-life function is stopped immediately. The screen of FIG. 9 is displayed continuously for about 30 seconds. In the meantime, it is monitored the user's key operation (step S704). In this step, if the user has operated any key, a message to stop the operation of the long-life function as shown in FIG. 10 is displayed. Then, after the TV set is changed to the program viewing mode with the power on (step S705), the processing procedure is completed.

On the other hand, if the user has not operated any key in step S704, the pictorial patters are displayed sequentially (step S706). Specifically, the pictorial patterns stored in the ROM 110 are read in sequence and pass through the video processor 104 and display controller 105, which convert the patterns into video signals. The converted patterns appear on the display 106 sequentially.

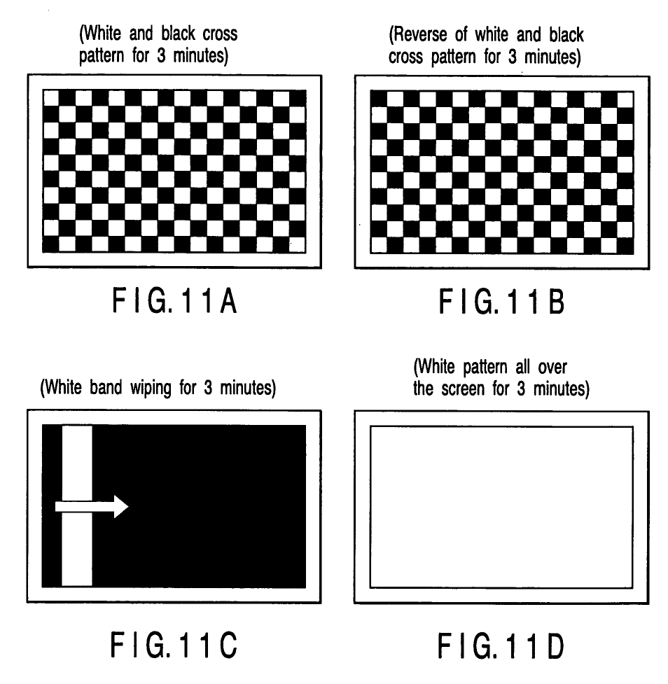

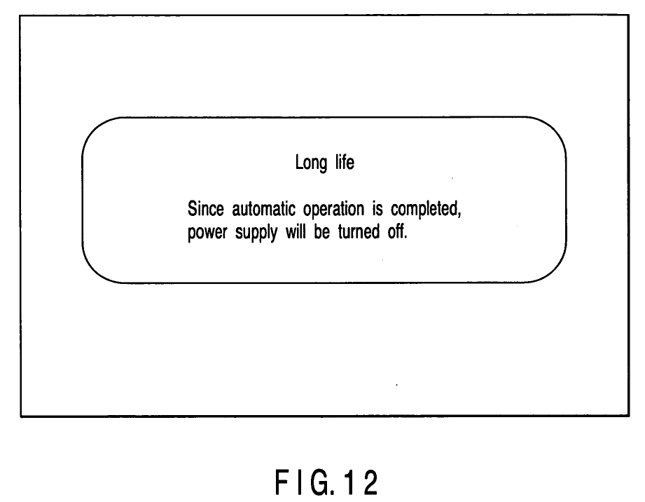

FIG. 11 shows the pictorial patters and an example of the order in which the patterns are displayed. The pictorial patters include, for example, four types shown in FIGS. 11(A) to 11(D). Of course, more than four types of patters may be prepared. The pattern in FIG. 11(A) is a white and black cross pattern (or a checkered pattern). FIG. 11(B) is the reverse of the pattern in FIG. 11(A). FIG. 11(C) is a pattern where a black background is traced from left to right with a white band (this is called wiping). FIG. 11(D) is a pattern where all the area of the screen makes a white background. A method of displaying these patterns (A) to (D) one after another at intervals of three minutes can be considered.

Of course, much more pictorial patters may be prepared and displayed in sequence. A certain pattern may be displayed for a longer time or a shorter time or repeatedly. In addition, for example, if the display time of the pattern in FIG. 11(C) is set to zero, it is possible to skip from pattern (B) to pattern (D).

In FIG. 8, it is monitored whether there is a key operation, while the pictorial patterns are being displayed (step S707). If there is any key operation, the procedure goes to step S705, where a message in FIG. 10 appears and then the long-life function is interrupted. If all of the pictorial patterns have been displayed without any key operation, a message to end the operation of the long-life function as shown in FIG. 11 is displayed (step S708) and the screen remains in this state for about 30 seconds. In the meantime, it is monitored whether there is any key operation (step S709). If there is any key operation, the procedure goes to step S705, where the long-life function is interrupted. If there is any key operation, the power supply of the TV set is turned off (step S710) and the process is completed (step S711).

As described above, in the first embodiment, the long-life function of displaying a plurality of pictorial patterns on the display 106 sequentially has been newly introduced. Displaying a plurality of pictorial patterns enhances the effect of reducing the burn-in of the display 16 caused by an individual pictorial pattern, which makes the screen protecting effect greater. In the first embodiment, when the preset start time has been reached, the long-life function is started automatically. In this way, use of the timer function enables the long-life function to operate automatically and periodically, such as every day, every other day, or every other week. This reduces the user's load. Furthermore, since the user can select a start setting time freely, it is possible to prevent the long-life function from starting as much as possible while watching television. Accordingly, it is possible to provide a user-friendly video display apparatus. Therefore, the user's load can be reduced and burn-in can be alleviated effectively.

[Second Embodiment]

A second embodiment of the present invention is such that the long-life function is started in such a manner that it is interlocked with the turning off of the power supply of the TV set. To distinguish the long-life function in the second embodiment from that in the first embodiment, the long-life function in the second embodiment is expressed as the long-life function (before power-off).

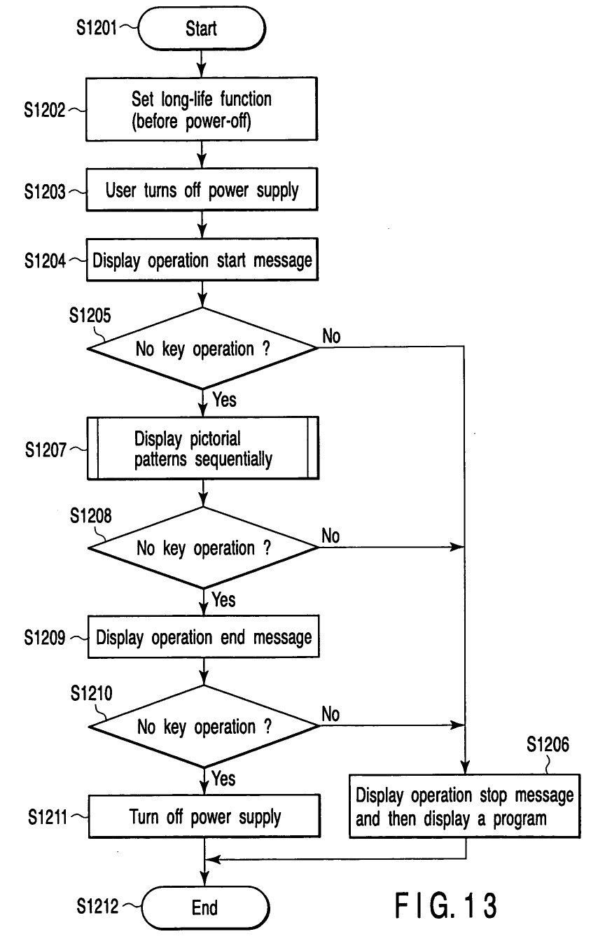

FIG. 13 is a flowchart to help explain the processing procedure in the second embodiment of the video display apparatus in FIGS. 1 and 2. In FIG. 13, when the process is started in step S1201, the enable/disable of the long-life function (before power-off) is set. At this time, a menu screen as shown in FIG. 5 appears on the display 106. From the screen, the user selects and specifies whether the long-life function (before power-off) is to be operated (or on) or not (or off) (step S1202). The specified set information is held in the ROM 110. If the long-life function is to be off, the long-life function (before power-off) is not started.

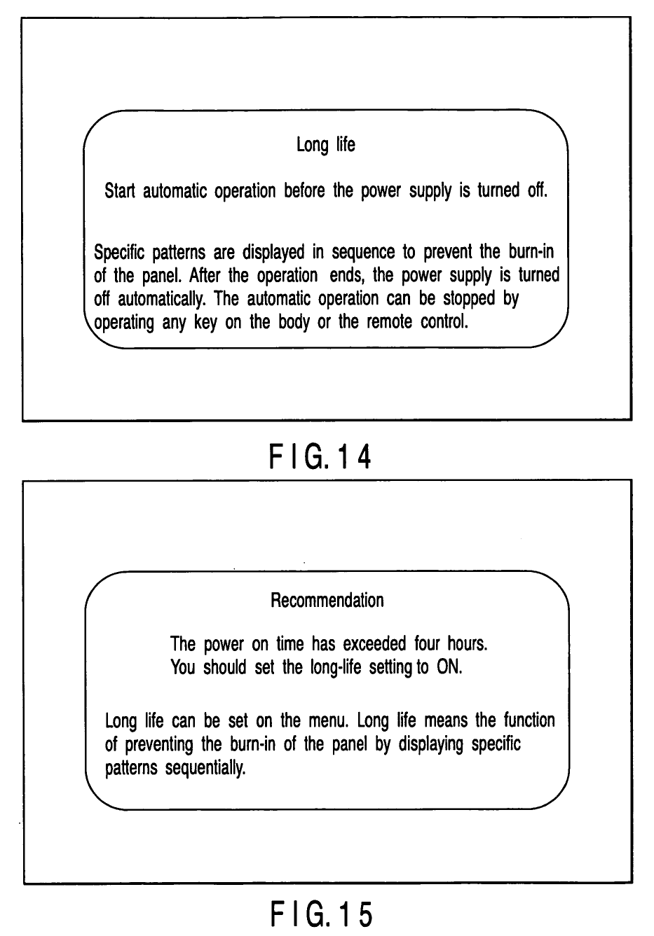

Suppose the long-life function (before power-off) is specified that it is to be on (the enable mode) and, in this state, the user turns off the power supply of the TV set with the remote control (step S1203). Then, a message screen in FIG. 14 appears (step S1204). On the screen of FIG. 14, a message to start the long-life function (before power-off) is displayed.

The screen of FIG. 14 is displayed continuously for about 30 seconds. In the meantime, it is monitored whether the user has operated any key (step S1205). If the user has operated any key, a message of FIG. 10 is displayed (step S1206) and the user is informed of the stop of the operation of the long-life function (before power-off). Then, after the state of the TV set is changed to the program viewing mode with the power on, the processing procedure is completed (step S1212).

On the other hand, if in step S1205, the user has operated no key, the sequential display of the pictorial patterns is started (step S1207). That is, a plurality of pictorial patterns appear on the display sequentially as in the first embodiment. While each pattern is being displayed, it is monitored whether there is any key operation (step S1208). If there is any key operation, the pattern display is interrupted and the mode returns to the viewing mode. If all of the pictorial patterns have been displayed without any key operation, a message as shown in FIG. 11 appears, thereby informing the user of the end of the operation of the long-life function (before power-off) (step S1209). If there is any key operation in this state, the long-life function (before power-off) is interrupted, the mode goes into the viewing mode. If there is no key operation (Yes in step S1220), the power supply of the TV set is turned off at this stage (step S1211) and the process is completed (step S1212).

As described above, in the second embodiment, the long-life function is started in such a manner that it is interlocked with the power-off operation to bring the TV set into the standby state and the power supply of the TV set is turned off after the display of a screen pattern is completed. By doing this, the second embodiment not only produces the same effect as the first embodiment but also reduce the user's load because there is no need to set the start time.

[Third Embodiment]

A third embodiment of the present invention is such that the way of displaying pictorial patterns is changed according to the operating time of the display 106. The method of the third embodiment may be combined with either the first or the second embodiment.

In the third embodiment, the clock section 108d measures the operating time of the display 106. Specifically, the accumulated time during which the power supply of the TV set is on and the elapsed time since the TV set was turned on last are measured. The accumulated time is referred to as the total time and the elapsed time is referred to as the one-time time. The total time and one-time time are both stored in the ROM 110 every moment.

In the third embodiment, when the one-time time has exceeded a specified value in a state where the long-life function is cancelled, that is, where the disable mode is on, a message to recommend the start of the long-life function is caused to appear on the display 106. FIG. 15 shows an example of a start recommend screen. The specified value is assumed to be, for example, four hours. If the one-time time has exceeded four hours, a message as shown in FIG. 15 is displayed, thereby prompting the user to set or start the long-life function. By such a process, burn-in can be prevented in the early stages, even when the long-life function has been cancelled.

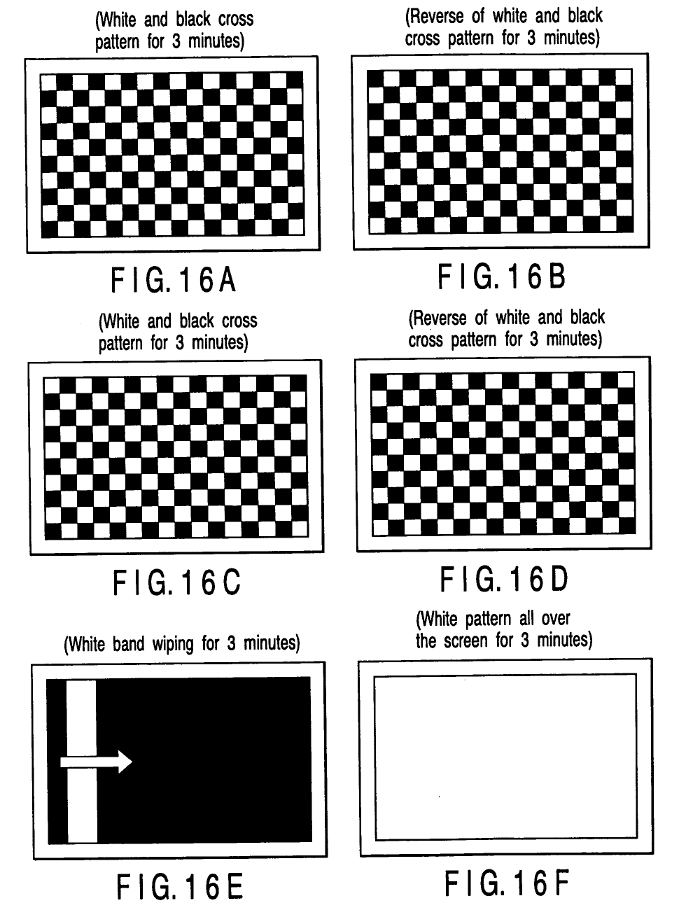

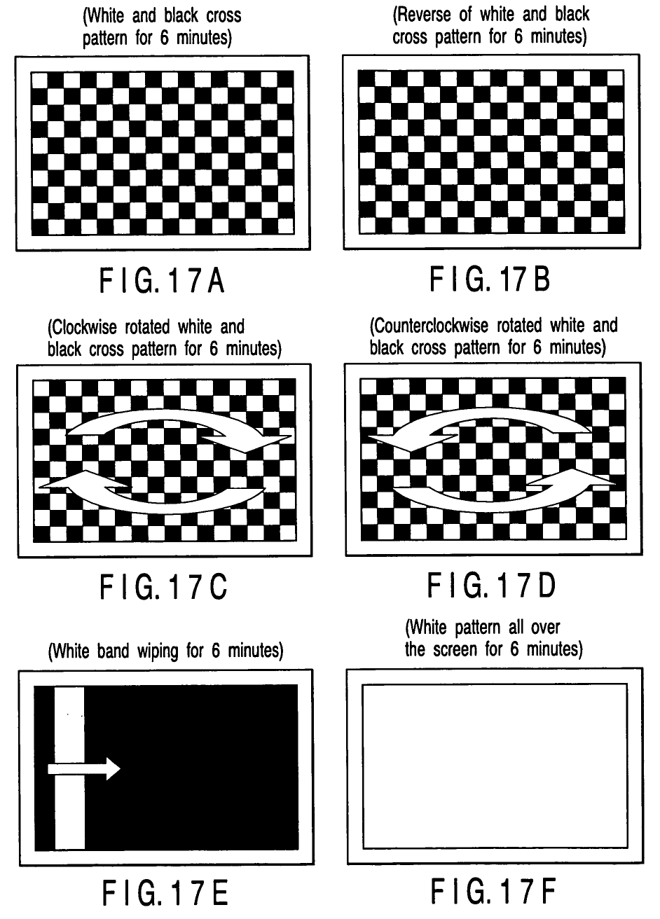

Furthermore, in the third embodiment, the order in which the respective patters are displayed, the display time of each of the patterns, and others are changed, using either the one-time time or the total time, or both of them as a parameters or parameters. That is, the way of displaying the pictorial patterns is not limited to what is shown in FIG. 11 and may be changed variously. In addition to the display mode in FIG. 11, another display mode as shown in, for example, FIGS. 16 and 17 can be considered. In the display mode of FIG. 16, a reversed checkered pattern of FIG. 11(B) is followed by the repetition of the pattern of FIG. 11(A) and that of FIG. 11(B). The display time of each pattern is not restricted to three minutes and may be changed freely. In the display mode of FIG. 17, the pattern of FIG. 16(C) is rotated clockwise and the pattern of FIG. 16(D) is rotated counterclockwise. Let the modes in FIGS. 11, 16, and 17 be pattern A, pattern B, and pattern C, respectively. From the types of pictorial patterns and their display time, it is seen that pattern C has the greatest effect of reducing burn-in, followed by pattern B and pattern A in that order.

In the third embodiment, when the long-life function is started, any one of pattern A to pattern C is selectively started on the basis of the one-time time. For example, when the one-time time is in the range of 0 to 2 hours, pattern A is started automatically. When the one-time time is in the range of 2 to 4 hours, pattern B is started automatically. When the one-time time is 4 hours or more, pattern C is started automatically. That is, in step S706 of FIG. 7 and in step S1207 of FIG. 13, a pattern to be operated is determined on the basis of the one-time time. Moreover, in the third embodiment, in a state where the total time has exceeded 10000 hours, pattern C is started unconditionally, regardless of the one-time time.

As described above, with the third embodiment, a message to recommend the start of the long-life function is displayed according to a combination of the one-time time and the total time, thereby informing the user of the recommendation. In addition, with the third embodiment, a more suitable display mode of pictorial patterns is selected automatically according to the operating time of the display 106. These improve the burn-in reducing effect further.

The present invention is not limited to the above embodiments. For example, while in the above embodiments, the invention has been applied to a plasma display, it may be applied to such a display apparatus as a CRT. Since the main part of the present invention has been realized by the software processing of the control section 108, the invention may be applied to a set top-box. Specifically, the functional block of FIG. 1 can be separated into a part enclosed with a single-dot-dash line and the remaining part. Only the part enclosed with a single-dot-dash lie is a set top-box (STB). The set top-box is widely used to output a video signal to a display apparatus, such as the display 106.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A video display apparatus which causes phosphors coated on a screen to emit light, thereby displaying images on the screen, the video display apparatus comprising:
a storage section which stores a plurality of pictorial patterns;
a pattern displaying function which displays the pictorial patterns stored in the storage section on the screen sequentially; and
a start-up section which causes the pattern displaying function to start automatically, when a preset start condition is satisfied and carry out a pictorial pattern displaying process.

2. The video display apparatus according to claim 1, further comprising a setting section which enables the user to set a start time, wherein the start-up section starts the pattern displaying function, when the start time has been reached.

3. The video display apparatus according to claim 2, wherein the start-up section turns on the power supply of the apparatus to start the pattern displaying function, when the start time has been reached, with the power supply of the apparatus being off.

4. The video display apparatus according to claim 2, wherein the start-up section displays a message to ask the user whether to start the pattern displaying function, when the start time has been reached with the power supply of the apparatus being on and, when the user has given permission in response to the message, starts the pattern displaying function.

5. The video display apparatus according to claim 1, wherein the start-up section starts the pattern displaying function when the power supply has been turned off and, after the pictorial pattern displaying process is completed, turns off the power supply of the apparatus.

6. The video display apparatus according to claim 1, further comprising:
a clock section which measures the accumulated time during which the power supply of the apparatus is on; and
a display varying section which varies at least one of the order in which the respective pictorial patterns are displayed and the display time of each of the pictorial patterns, according to the accumulated time.

7. The video display apparatus according to claim 6, further comprising:
a mode select section which enables the user to select either an enable mode in which the start-up section is caused to start the pattern displaying function when the start condition is fulfilled or a disable mode in which the start-up section is prevented from starting the pattern displaying function, regardless of the start condition; and
a message display section which displays on the screen a message to prompt the user to start the pattern displaying function, when the accumulated time has exceeded a specified value in a state where the disable mode has been selected at the mode select section.

8. The video display apparatus according to claim 1, further comprising:
a clock section which measures the elapsed time since the power supply of the apparatus was turned on last; and
a display varying section which varies at least one of the order in which the respective pictorial patterns are displayed and the display time of each of the pictorial patterns, according to the elapsed time.

9. The video display apparatus according to claim 8, further comprising:
a mode select section which enables the user to select either an enable mode in which the start-up section is caused to start the pattern displaying function when the start condition is fulfilled or a disable mode in which the start-up section is prevented from starting the pattern displaying function, regardless of the start condition; and
a message display section which displays on the screen a message to prompt the user to start the pattern displaying function, when the elapsed time has exceeded a specified value in a state where the disable mode has been selected at the mode select section.

10. A video signal output apparatus which outputs a video signal to a display apparatus that causes phosphors coated on a screen to emit light to display images on the screen and which causes the display apparatus to display an image on the basis of the video signal, the video signal output apparatus comprising:
a storage section which stores a plurality of pictorial patterns;
a pattern displaying function which displays the pictorial patterns stored in the storage section on the screen sequentially; and
a start-up section which causes the pattern displaying function to start automatically when a preset start condition is satisfied and carry out a pictorial pattern displaying process.

11. The video signal output apparatus according to claim 10, characterized by further comprising a setting section which enables the user to set a start time,
wherein the start-up section starts the pattern displaying function, when the start time has been reached.

12. The video signal output apparatus according to claim 11, wherein the start-up section turns on the power supply of the display apparatus to start the pattern displaying function, when the start time has been reached with the power supply of the display apparatus being off.

13. The video signal output apparatus according to claim 11, wherein the start-up section displays on the screen a message to ask the user whether to start the pattern displaying function, when the start time has been reached with the power supply of the display apparatus being on and, when the user has given permission in response to the message, starts the pattern displaying function.

14. The video signal output apparatus according to claim 10, wherein the start-up section starts the pattern displaying function when the power supply of the display apparatus has been turned off and, after the pictorial pattern displaying process is completed, turns off the power supply of the display apparatus.

15. The video signal output apparatus according to claim 10, further comprising:
a clock section which measures the accumulated time during which the power supply of the display apparatus is on; and
a display varying section which varies at least one of the order in which the respective pictorial patterns are displayed and the display time of each of the pictorial patterns, according to the accumulated time.

16. The video signal output apparatus according to claim 15, further comprising:
a mode select section which enables the user to select either an enable mode in which the start-up section is caused to start the pattern displaying function when the start condition is fulfilled or a disable mode in which the start-up section is prevented from starting the pattern displaying function, regardless of the start condition; and
a message display section which displays on the screen a message to prompt the user to start the pattern displaying function, when the accumulated time has exceeded a specified value in a state where the disable mode has been selected at the mode select section.

17. The video signal output apparatus according to claim 10, further comprising:
a clock section which measures the elapsed time since the power supply of the display apparatus was turned on last; and
a display varying section which varies at least one of the order in which the respective pictorial patterns are displayed and the display time of each of the pictorial patterns, according to the elapsed time.

18. The video signal output apparatus according to claim 17, further comprising:
a mode select section which enables the user to select either an enable mode in which the start-up section is caused to start the pattern displaying function when the start condition is fulfilled or a disable mode in which the start-up section is prevented from starting the pattern displaying function, regardless of the start condition; and
a message display section which displays on the screen a message to prompt the user to start the pattern displaying function, when the elapsed time has exceeded a specified value in a state where the disable mode has been selected at the mode select section.

19. A pictorial pattern displaying method used in a video display apparatus which causes phosphors coated on a screen to emit light, thereby displaying images on the screen, the pictorial pattern displaying method comprising:
a pattern displaying step of displaying a plurality of pictorial patterns differing from one another on the screen sequentially;
a time setting step of presetting a start time at which the pattern displaying step is to be started; and
a starting step of starting the pattern displaying step automatically, when the start time set in the time setting step has been reached.

20. The pictorial pattern displaying method according to claim 19, further comprising an inquiry step of displaying on the screen a message to ask the user whether to start the pattern displaying step, when the start time has been reached, with the power supply of the video display apparatus being on,
wherein the starting step starts the pattern displaying step, when the user has given permission in response to the message.

21. A pictorial pattern displaying method used in a video display apparatus which causes phosphors coated on a screen to emit light, thereby displaying images on the screen, the pictorial pattern displaying method comprising:
a waiting step of waiting for the power supply of the video display apparatus to be turned off; and
a pattern displaying step of displaying a plurality of pictorial patterns differing from one another on the screen sequentially, when the power supply has been turned off.

22. The pictorial pattern displaying method according to claim 19, further comprising:
a time measuring step of measuring the accumulated time during which the power supply of the video display apparatus is on; and
a display varying step of varying at least one of the order in which the respective pictorial patterns are displayed and the display time of each of the pictorial patterns, according to the accumulated time.

23. The pictorial pattern displaying method according to claim 21, further comprising:
a time measuring step of measuring the accumulated time during which the power supply of the video display apparatus is on; and
a display varying step of varying at least one of the order in which the respective pictorial patterns are displayed and the display time of each of the pictorial patterns, according to the accumulated time.

24. The pictorial pattern displaying method according to claim 19, further comprising:
a time measuring step of measuring the elapsed time since the power supply of the video display apparatus was turned on; and
a display varying step of varying at least one of the order in which the respective pictorial patterns are displayed and the display time of each of the pictorial patterns, according to the elapsed time.

25. The pictorial pattern displaying method according to claim 21, further comprising:
a time measuring step of measuring the elapsed time since the power supply of the video display apparatus was turned on; and
a display varying step of varying at least one of the order in which the respective pictorial patterns are displayed and the display time of each of the pictorial patterns, according to the elapsed time.
